(19) United States
(12) Patent Application Publication
(10) Pub. No.: US 2017/0167456 A1
(43) Pub. Date: Jun. 15, 2017

(54) GASOLINE-DIESEL COMPLEX COMBUSTION ENGINE

(71) Applicant: Hyundai Motor Company, Seoul (KR)

(72) Inventors: Hyunsung JUNG, Anyang-si (KR); Jae Hyeok Song, Busan (KR)

(73) Assignee: Hyundai Motor Company, Seoul (KR)

(21) Appl. No.: 15/210,186

(22) Filed: Jul. 14, 2016

(30) Foreign Application Priority Data
Dec. 14, 2015 (KR) 10-2015-0178660

(51) Int. Cl. F02M 43/04; F02F 1/42; F02D 19/06

(52) U.S. Cl. CPC F02M 43/04; F02D 19/0692; F02D 19/0689; F02F 1/4285; F02F 2001/241

(57) ABSTRACT

A gasoline-diesel complex combustion engine may include a cylinder including a cylinder body in which a combustion chamber is formed to generate a driving power by combusting a gasoline fuel and a diesel fuel and a cylinder head formed to cover an upper portion of the cylinder body, a pair of intake ports formed in the cylinder head, a pair of exhaust ports formed in the cylinder head, a diesel injector disposed in a center of the cylinder head, a pair of spark plugs disposed on opposite sides of the diesel injector, a first intake pipe and a second intake pipe mounted in the intake ports, an exhaust pipe mounted in the exhaust ports, a pair of intake valves disposed in the first and second intake pipes, and a gasoline injector disposed in the first and second intake pipes to inject the gasoline fuel into the combustion chamber.

### CROSS-REFERENCE TO RELATED APPLICATION

The present application claims priority to Korean Patent Application No. 10-2015-0178660, filed Dec. 14, 2015, the entire contents of which is incorporated herein for all purposes by this reference.

### BACKGROUND OF THE INVENTION

Field of the Invention

The present invention relates to a gasoline-diesel complex combustion engine, and more particularly, to a structure of a gasoline-diesel complex combustion engine that is driven by using a mixture of a gasoline fuel and a diesel fuel.

Description of Related Art

Generally, a diesel engine has excellent fuel efficiency, but exhausts a lot of contaminated materials such as nitrogen oxides (NOx) and the like. On the other hand, a gasoline engine has relatively lower fuel efficiency, but exhausts fewer contaminated materials such as nitrogen oxides (NOx) and the like as compared with the diesel engine.

Recently, exhaust gas regulations for diesel engine vehicles have been tightened, so development of a novel diesel engine has been required.

As an example of the novel diesel engine, a gasoline-diesel complex combustion engine that is driven by using a mixture of a gasoline fuel and a diesel fuel is in development.

The gasoline-diesel complex combustion engine intakes a mixture gas that the gasoline fuel and air are premixed in an intake stroke and injects the diesel fuel to control an ignition in a compression stroke. Then, the diesel fuel is compressed and thus ignited in an ignition stroke. At this time, the gasoline fuel is also ignited. Finally, the diesel fuel and the gasoline fuel are combusted in an explosion stroke, thereby generating a driving power. However, the gasoline fuel and the diesel fuel may be ignited by using a spark plug depending on a proportion of the gasoline fuel and the diesel fuel.

A conventional gasoline-diesel complex combustion engine is driven by complex combustion of the gasoline fuel and the diesel fuel when the engine is in a low load condition or a middle load condition, and the engine is driven by single combustion of the gasoline fuel when the engine is in a high load condition.

As such, a driving condition in which the engine is driven by the complex combustion is distinguished from a driving condition in which the engine is driven by the single combustion using only the gasoline fuel, so a swirl ratio Rs, a tumble ratio Rt, and charging efficiency Cf are required to be appropriately determined according to each of the driving conditions.

Further, a distance of a flame propagated from an ignition source of the diesel fuel to a total fuel that is obtained by mixing the gasoline fuel and the diesel fuel is increased depending on positions of a gasoline injector, a diesel injector, or the like in a combustion chamber and a shape of the combustion chamber in the conventional gasoline-diesel complex combustion engine, so knocking may be increased.

Further, when the spark plug is employed, the knocking may be generated by quenching of a cylinder head, which is caused by a flame of a fuel ignited by the spark plug.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a gasoline-diesel complex combustion engine having advantages of being capable of optimizing a swirl ratio Rs, a tumble ratio Rt, and charging efficiency Cf depending on a driving condition. The present invention has been made in an effort to provide a gasoline-diesel complex combustion engine having advantages of being capable of preventing knocking in a combustion operation.

According to various aspects of the present invention, a gasoline-diesel complex combustion engine may include a cylinder including a cylinder body in which a combustion chamber is formed to generate a driving power by combusting a gasoline fuel and a diesel fuel and a cylinder head formed to cover an upper portion of the cylinder body, a pair of intake ports formed in the cylinder head, a pair of exhaust ports formed in the cylinder head and positioned symmetrically to the intake ports, a diesel injector disposed in a center of the cylinder head to inject the diesel fuel into the combustion chamber, a pair of spark plugs disposed on opposite sides of the diesel injector in the cylinder head, a first intake pipe and a second intake pipe mounted in the intake ports to selectively supply air to the combustion chamber, an exhaust pipe mounted in the exhaust ports to exhaust an exhaust gas generated in the combustion chamber, a pair of intake valves disposed in the first and second intake pipes to selectively open the intake ports, and a gasoline injector disposed in the first and second intake pipes to inject the gasoline fuel into the combustion chamber, in which the first intake pipe may be obliquely formed at a predetermined angle in an upward direction of the cylinder head and in an opposite direction to the exhaust ports in a side view and extend linearly in the opposite direction to the exhaust ports in a plane view, and the second intake pipe may be obliquely formed at a predetermined angle in the upward direction of the cylinder head and in the opposite direction to the exhaust ports in the side view and extend linearly in the opposite direction to the exhaust ports in the plane view, while an end portion of the second intake pipe, which is connected to one of the intake ports is externally obliquely formed at a predetermined angle in a radial direction from a center of the cylinder head with respect to the diesel injector.

The diesel injector may be disposed at the center of the cylinder head.

The spark plugs may be disposed symmetrically to each other with respect to the diesel injector.

A bottom surface of the cylinder head may include a pair of inclined portions including a first inclined portion in which the intake ports are formed and a second inclined portion in which the exhaust ports are formed, and an edge portion in which the inclined portions contact each other, in which a pent-roof shape may be formed by the inclined portions and the edge portion.

The intake ports and the exhaust ports may be respectively formed in inclined portions.

The gasoline-diesel complex combustion engine of claim 4, wherein the diesel injector may be disposed at a center of the edge portion.

The gasoline injector may be mounted in the intake pipes such that an injection direction in which the gasoline fuel is injected from the gasoline injectors is oriented directly toward the intake valves.

According to the above-described exemplary embodiments of the present invention, the gasoline-diesel complex combustion engine may be designed optimally to have a swirl ratio, a tumble ratio, and a charging efficiency that are appropriate thereto.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating a configuration of an engine system including an exemplary gasoline-diesel complex combustion engine according to the present invention.

FIG. 2 is a perspective view illustrating a cylinder of the exemplary gasoline-diesel complex combustion engine according to the present invention.

FIG. 3 is a perspective view illustrating a cylinder head of the exemplary gasoline-diesel complex combustion engine according to the present invention.

FIG. 4 is a cross-sectional view taken along line A-A′ in FIG. 3.

FIG. 5 is a cross-sectional view taken along line B-B′ in FIG. 3.

FIG. 6 is a cross-sectional view taken along line C-C′ in FIG. 3.

FIG. 7 is a top plan view illustrating a configuration of an intake pipe and an exhaust pipe according to the present invention.

FIG. 8 is a side view illustrating a configuration of an intake pipe and an exhaust pipe according to the present invention.

FIG. 9 illustrates an operation of the exemplary gasoline-diesel complex combustion engine according to the present invention.

FIG. 10 illustrates an operation of the exemplary gasoline-diesel complex combustion engine according to the present invention.

FIG. 11 illustrates an operation of the exemplary gasoline-diesel complex combustion engine according to the present invention.

FIG. 12 illustrates an operation of the exemplary gasoline-diesel complex combustion engine according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

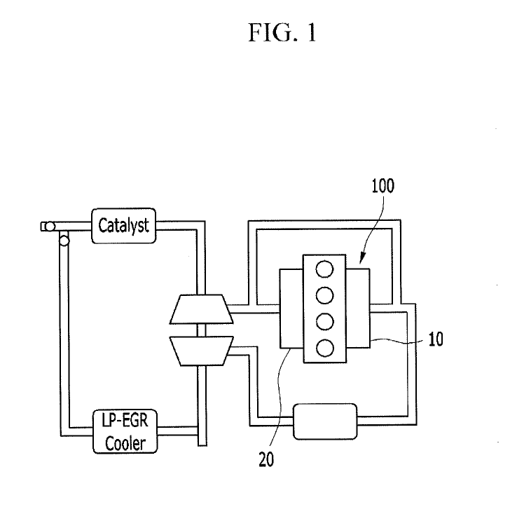

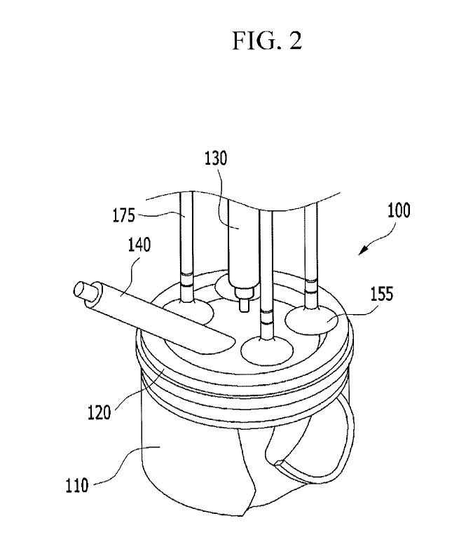

FIG. 1 is a schematic view illustrating a configuration of an engine system including a gasoline-diesel complex combustion engine according to various embodiments of the present invention. FIG. 2 is a perspective view illustrating a cylinder of a gasoline-diesel complex combustion engine according to various embodiments of the present invention.

As shown in FIG. 1, a cylinder 100 of the gasoline-diesel complex combustion engine according to various embodiments of the present invention includes a combustion chamber configured to generate a driving power by combusting a fuel.

The cylinder 100 includes a cylinder body 110 in which the combustion chamber configured to generate the driving power by combusting a gasoline fuel and a diesel fuel is formed and a cylinder head 120 configured to cover an upper portion of the cylinder body 110.

The cylinder body 110 is configured to have a substantially cylindrical shape in which the combustion chamber is formed, and an upper portion of the cylinder body 110 is open. The cylinder head 120 is configured to cover the open upper portion of the cylinder body 110.

A diesel injector 130 configured to inject the diesel fuel into the combustion chamber and a gasoline injector 160 configured to inject the gasoline fuel into the combustion chamber are mounted to the cylinder 100.

Further, a spark plug 140 is mounted to the cylinder 100 to ignite a fuel mixture of the gasoline fuel and the diesel fuel, injected into the combustion chamber.

Hereinafter, a structure of the cylinder 100 according to various embodiments of the present invention will be described in detail.

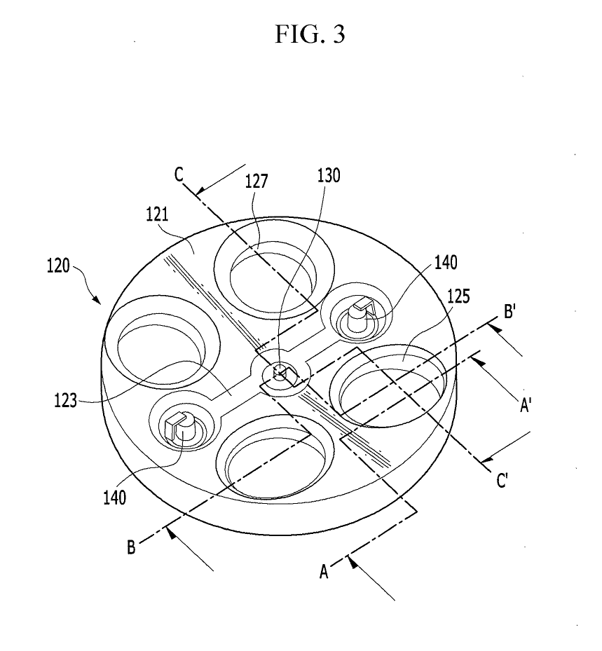

FIG. 3 is a perspective view illustrating the cylinder head 120 of a gasoline-diesel complex combustion engine according to various embodiments of the present invention. FIG. 3 illustrates a shape of the cylinder head 120 when seen from a bottom side.

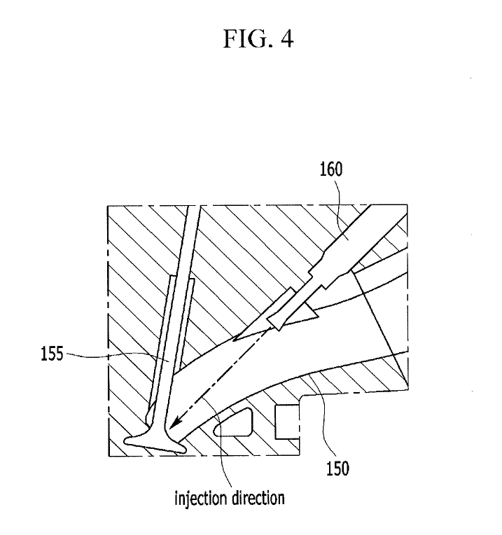

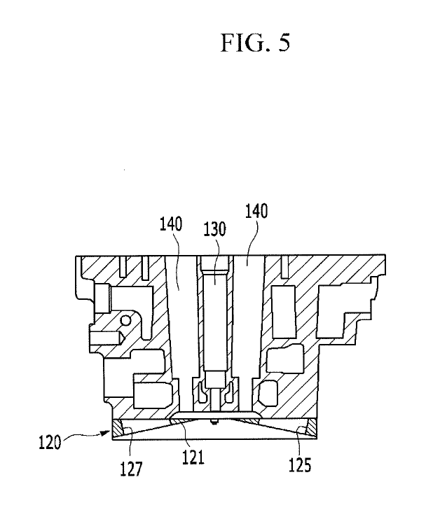

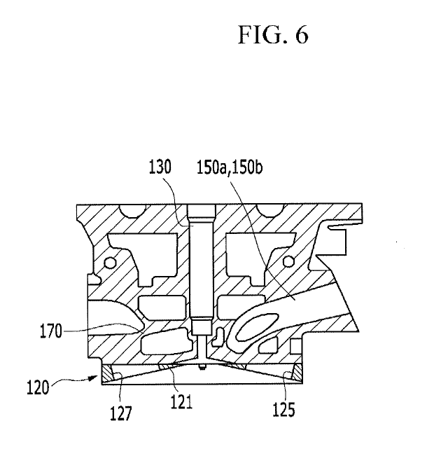

FIG. 4 is a cross-sectional view taken along line A-A′ in FIG. 3, FIG. 5 is a cross-sectional view taken along line B-B′ in FIG. 3, and FIG. 6 is a cross-sectional view taken along line C-C′ in FIG. 3.

As shown in FIG. 3 to FIG. 6, the cylinder head 120 is formed to have such a substantial disk shape so as to cover the upper portion of the cylinder body 110. A bottom surface of the cylinder head 120 includes a pair of inclined portions 121 and an edge portion 123 at which the inclined portions 121 contact each other. The cylinder head 120 is formed to have a pent-roof shape by the inclined portions 121 and the edge portion 123.

A pair of intake ports 125 are disposed on one side of the inclined portions 121, and a pair of exhaust ports 127 are disposed on the other side of the inclined portions 121. Specifically, the intake ports 125 and the exhaust ports 127 are positioned to be symmetrical to each other with respect to the edge portion 123.

The diesel injector 130 that injects the diesel fuel into the combustion chamber may be disposed at a center of the cylinder head 120. For example, the diesel injector 130 may be disposed at a center of the edge portion 123.

The spark plugs 140 may include a pair of spark plugs 140 which are disposed on opposite sides of the diesel injector 130. In this case, the spark plugs 140 may be disposed symmetrically to each other with respect to the diesel injector 130. The spark plugs 140 ignite the fuel mixture of the gasoline fuel and the diesel fuel, which is introduced into the combustion chamber.

As the spark plugs 140 are disposed symmetrically to each other with respect to the diesel injector 130, a distance (hereinafter, referred to as a flame-propagating distance) of a flame generated by the spark plugs 140 which is propagated to a total fuel mixture may be minimized.

When the flame-propagating distance is minimized as above, a quenching effect that the bottom surface of the cylinder head 120 is heated by the flame generated by the spark plugs 140 may be decreased, thereby preventing knocking from occurring.

An intake pipe 150 for supplying fresh air to the combustion chamber through an intake manifold 10 is connected to the intake ports 125. An exhaust pipe 170 for exhausting an exhaust gas generated in the combustion chamber is connected to the exhaust ports 127. The exhaust gas generated in the combustion chamber is exhausted through the exhaust ports 127 and the exhaust pipe 170, and is externally exhausted through an exhaust manifold 20.

Further, the gasoline injector 160 is included in the intake pipe 150 to supply the gasoline fuel to an interior of the combustion chamber. The gasoline injector 160 may be a gasoline multi-point injector (MPI) for injecting a mixture of air and the gasoline fuel into the combustion chamber of the engine. Alternatively, the gasoline injector 160 may be a gasoline direct injector (GDI) that injects the gasoline fuel directly into the combustion chamber of the engine.

An intake valve 155 is mounted to the intake pipe 150 to selectively open the intake ports 125. In this case, the gasoline injectors 160 may be mounted to face the intake valves 155. Specifically, the gasoline injector 160 may be mounted to the intake pipe 150 such that an injection direction in which the gasoline fuel is injected therefrom is headed directly toward the intake valve 155.

Since the gasoline injector 160 is mounted such that the injection direction of the gasoline fuel injected therefrom is directly headed toward the intake valve 155, the gasoline injector 160 may be mounted adjacently to the intake ports 125.

As such, the air and the fuel injected from the gasoline injector 160 serve to cool the intake valve 155 which is heated during an explosion stroke as the gasoline injector 160 is mounted adjacently to the intake ports 125. As a result, the knocking may be prevented from occurring.

Hereinafter, a structure of the intake pipe 150 and the exhaust pipe 170 will be described in detail.

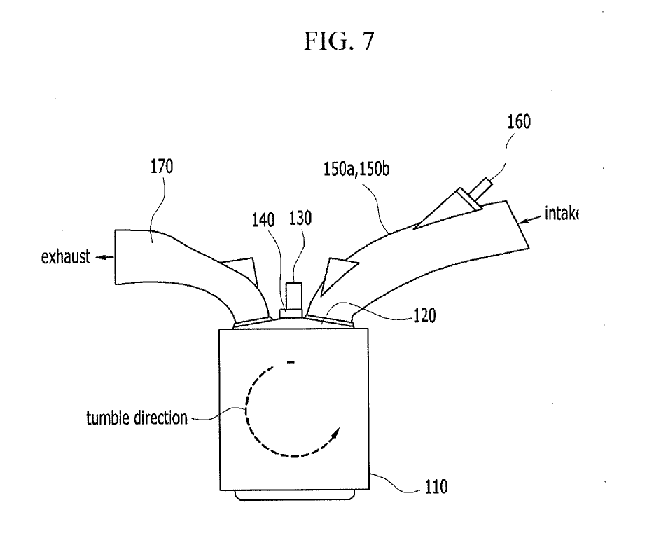

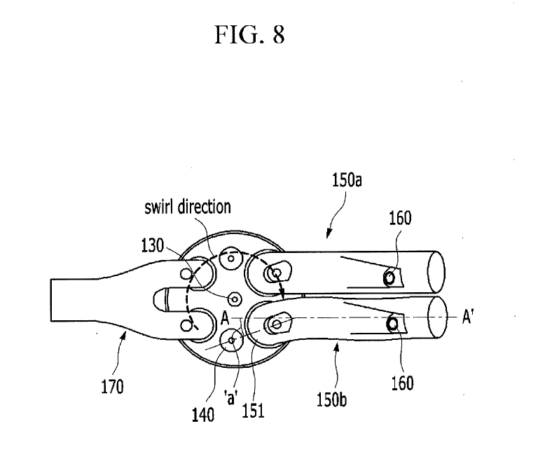

FIG. 7 is a top plan view illustrating a configuration of the intake pipe 150 and the exhaust pipe 170 according to various embodiments of the present invention. FIG. 8 is a side view illustrating the configuration of the intake pipe 150 and the exhaust pipe 170 according to various embodiments of the present invention.

As shown in FIG. 7 and FIG. 8, the intake pipe 150 may include a pair of intake pipes 150 including a first intake pipe 150a and a second intake pipe 150b. The first intake pipe and the second intake pipe are formed to generate a flow in the combustion chamber mainly in a tumble direction.

As shown in FIG. 7, the first intake pipe 150a is obliquely formed at a predetermined angle in an upward direction of the cylinder head 120 and in an opposite direction to the exhaust ports 127 in a side view. Further, as shown in FIG. 8, the first intake pipe 150a extends linearly in the opposite direction to the exhaust ports 127 in a plane view.

Accordingly, the air and the gasoline fuel introduced through the first intake pipe 150a generate a flow in a tumble direction since the first intake pipe 150a is obliquely formed at the predetermined angle in the upward direction of the cylinder head 120 and in the opposite direction to the exhaust ports 127 in the side view and extends linearly in the opposite direction to the exhaust ports 127 in the plane view.

As shown in FIG. 7, the second intake pipe 150b is obliquely formed at a predetermined angle in the upward direction of the cylinder head 120 and in the opposite direction to the exhaust ports 127 in the side view. Further, as shown in FIG. 8, the second intake pipe 150b extends substantially linearly in the opposite direction to the exhaust ports 127 in the plane view (refer to A-A). Herein, an end portion 151 of the second intake pipe 150b, which is connected to one of the intake ports 125 is externally obliquely formed at a predetermined angle ‘a’ in a radial direction from the center of the cylinder head 120 with respect to the diesel injector 130.

Accordingly, the air and the gasoline fuel introduced through the second intake pipe 150b generate a flow in a swirl direction in the combustion chamber since the end portion 151 is externally obliquely formed at a predetermined angle in the radial direction from the center of the cylinder head 120 with respect to the diesel injector 130.

Hence, the air and the gasoline fuel introduced through the first intake pipe 150a generate the flow mainly in the tumble direction, and the air and the gasoline fuel introduced through the second intake pipe 150b generate the flow mainly in the tumble direction. However, the flow in the swirl direction is slightly generated by the action of the end portion 151.

In the case of the gasoline-diesel complex combustion engine, load condition or a middle load condition is a complex combustion condition by the complex combustion of the gasoline fuel and the diesel fuel, and a high load condition is in a gasoline combustion condition by the single combustion of the gasoline fuel.

In such a complex combustion engine, it is important to optimize a swirl ratio and charging efficiency in the complex combustion condition, and it is important to optimize a tumble ratio and the charging efficiency in the gasoline combustion condition. That is, a configuration that may optimize all of the swirl ratio Rs, the tumble ratio Rt, and the charging efficiency Cf has much importance in the complex combustion engine.

Herein, the swirl ratio Rs designates a torque generated by the flow in the swirl direction, the tumble ratio Rt designates a torque generated by the flow in the tumble direction, and the charging efficiency Cf designates an amount of air introduced by a reference pressure difference between an intake and an exhaust.

Accordingly, all of the swirl ratio Rs, the tumble ratio Rt, and the charging efficiency Cf may be optimized by designing the intake ports of the complex combustion engine as disclosed in various embodiments of the present invention.

Hereinafter, an operation of the gasoline-diesel complex combustion engine according to various embodiments of the present invention will be described in detail with reference to the accompanying drawings.

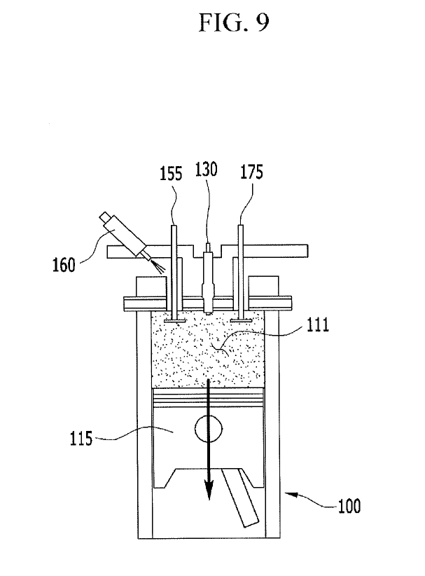

FIG. 9 to FIG. 12 illustrate the operation of the gasoline-diesel complex combustion engine according to the exemplary embodiment of the present invention.

Referring to FIG. 9, the intake valve 155 mounted to the intake pipe 150 opens the intake ports 125 to inject a pre-mixture of the air that is introduced through the intake manifold 10 and the gasoline fuel that is injected through the gasoline injector 160 into the combustion chamber in the intake stroke.

In this case, the gasoline injectors 160 are mounted to face the intake valves 155. Accordingly, the air and the gasoline fuel injected by the gasoline injector 160 cool the intakes valve 155, which is heated during the explosion stroke, whereby the knocking that occurs in a combustion operation may be suppressed.

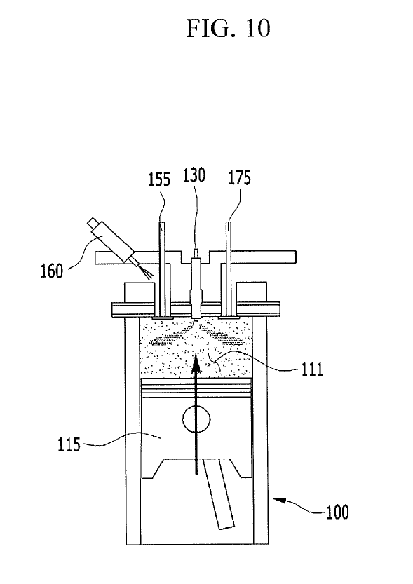

Referring to FIG. 10, when a piston is upwardly moved in the compression stroke, the piston compresses the pre-mixture of the air and the gasoline fuel, and the diesel fuel is injected into the combustion chamber through the diesel injector 130. The diesel fuel that is injected through the diesel injector 130 may be used to control an ignition of the gasoline fuel.

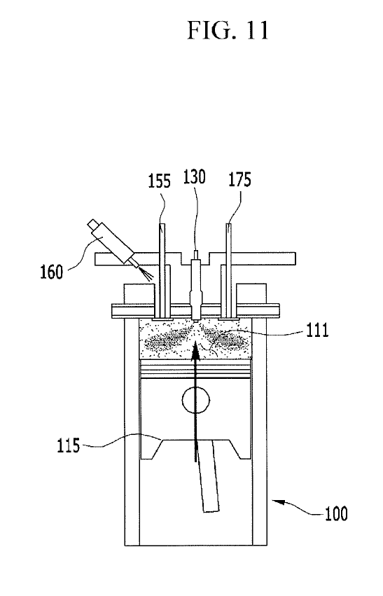

Referring to FIG. 11, an ignition occurs by compressing the diesel fuel injected according to the upward movement of the piston. The ignition may occur by the spark plugs 140 if necessary. In this case, the spark plugs 140 are mounted symmetrically to each other with respect to the diesel injector 130 that is disposed at the center of the cylinder head 120, and thus the flame-propagating distance of the flame generated by the spark plugs 140 propagated to the total fuel in the combustion chamber may be minimized.

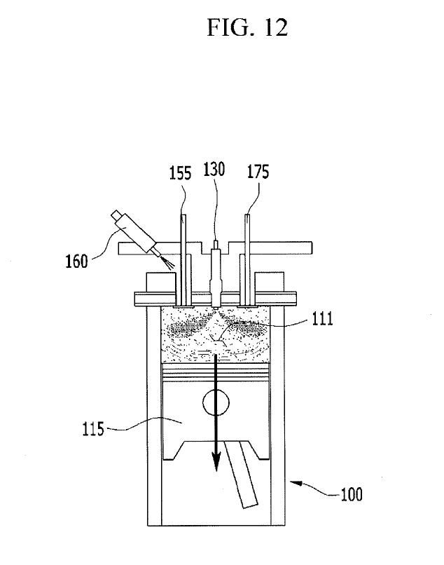

Referring to FIG. 12, the fuel mixture explodes by igniting the total fuel that is obtained by mixing the gasoline fuel and the diesel fuel, and the piston moves downward by a force of the explosion to generate the driving power. Then, the exhaust valves 175 are opened to exhaust the exhaust gas generated in the combustion operation to the exhaust manifold 20 through the exhaust ports 127.

Herein, since the cylinder head 120 is formed to have the pent-roof shape, a distance for a flame generated in the ignition stroke and the explosion stroke to reach the cylinder head 120 is sufficient to minimize heating of the cylinder head 120 due to the flame that has a high temperature. Accordingly, the knocking may be prevented.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gasoline-diesel complex combustion engine comprising:
a cylinder including a cylinder body in which a combustion chamber is formed to generate a driving power by combusting a gasoline fuel and a diesel fuel and a cylinder head formed to cover an upper portion of the cylinder body;
a pair of intake ports formed in the cylinder head;
a pair of exhaust ports formed in the cylinder head and positioned symmetrically to the intake ports;
a diesel injector disposed in a center of the cylinder head to inject the diesel fuel into the combustion chamber;
a pair of spark plugs disposed on opposite sides of the diesel injector in the cylinder head;
a first intake pipe and a second intake pipe mounted in the intake ports to selectively supply air to the combustion chamber;
an exhaust pipe mounted in the exhaust ports to exhaust an exhaust gas generated in the combustion chamber;
a pair of intake valves disposed in the first and second intake pipes to selectively open the intake ports; and
a gasoline injector disposed in the first and second intake pipes to inject the gasoline fuel into the combustion chamber,
wherein
the first intake pipe is obliquely formed at a predetermined angle in an upward direction of the cylinder head and in an opposite direction to the exhaust ports in a side view and extends linearly in the opposite direction to the exhaust ports in a plane view; and
the second intake pipe is obliquely formed at a predetermined angle in the upward direction of the cylinder head and in the opposite direction to the exhaust ports in the side view and extends linearly in the opposite direction to the exhaust ports in the plane view, while an end portion of the second intake pipe, which is connected to one of the intake ports is externally obliquely formed at a predetermined angle in a radial direction from a center of the cylinder head with respect to the diesel injector.

2. The gasoline-diesel complex combustion engine of claim 1, wherein the diesel injector is disposed at the center of the cylinder head.

3. The gasoline-diesel complex combustion engine of claim 2, wherein the spark plugs are disposed symmetrically to each other with respect to the diesel injector.

4. The gasoline-diesel complex combustion engine of claim 1, wherein a bottom surface of the cylinder head comprises:
a pair of inclined portions comprising a first inclined portion in which the intake ports are formed and a second inclined portion in which the exhaust ports are formed; and
an edge portion in which the inclined portions contact each other, and
wherein a pent-roof shape is formed by the inclined portions and the edge portion.

5. The gasoline-diesel complex combustion engine of claim 4, wherein the intake ports and the exhaust ports are respectively formed in inclined portions.

6. The gasoline-diesel complex combustion engine of claim 4, wherein the diesel injector is disposed at a center of the edge portion.

7. The gasoline-diesel complex combustion engine of claim 1, wherein the gasoline injector is mounted in the intake pipes such that an injection direction in which the gasoline fuel is injected from the gasoline injectors is oriented directly toward the intake valves.
